(19) United States
(12) Patent Application Publication
(10) Pub. No.: US 2017/0058811 A1
(43) Pub. Date: Mar. 2, 2017

(54) SYSTEM AND METHOD FOR TUNING A VEHICLE ENGINE CONTROL UNIT

(71) Applicant: Gluon, LLC, Livermore, CA (US)

(72) Inventors: Sameer Misson, Livermore, CA (US); Hakam Misson, Livermore, CA (US)

(21) Appl. No.: 15/012,070

(22) Filed: Feb. 1, 2016

Related U.S. Application Data
(60) Provisional application No. 62/209,817, filed on Aug. 25, 2015.

(51) Int. Cl. F02D 41/24; F02P 5/15; F02D 41/04; G05B 13/02

(52) U.S. Cl. CPC F02D 41/2406; G05B 13/021; F02P 5/1502; F02D 41/04

(57) ABSTRACT

A device, and associated methods of operation, for adjusting automotive operational parameters of a vehicle to improve automotive performance. The device includes a connector configured to mate with an on-board diagnostics port of the vehicle. The device further includes a processor configured to communicate with an engine control unit of the vehicle when the connector is mated with the on-board diagnostics port. The processor obtains information from the engine control unit, such as vehicle identification information and diagnostics information. The obtained information is transmitted to a remote database for processing via a transmitter of the dongle device. After the information is processed, the processor receives instructions from the database for adjusting the engine control unit and transmits the instructions to the engine control unit to adjust select operational parameters.

### RELATED APPLICATION DATA

This application is a nonprovisional of and claims the benefit under 35 U.S.C. §119(e) of U.S. Provisional Patent Application No. 62/209,817, filed Aug. 25, 2015, the disclosure of which is incorporated by reference herein in its entirety.

### BACKGROUND

The field of the present disclosure relates generally to systems and methods for monitoring and adjusting automotive operation, and in particular, to such systems and related methods for streamlining and simplifying a process of running diagnostics and tuning/adjusting one or more parameters of a vehicle engine control unit.

In a modern vehicle, an engine control unit (ECU) controls various components of an internal combustion engine to ensure optimal engine performance. Typically, the ECU obtains data from a plurality of sensors within the engine bay and uses lookup tables or other mapping tools to analyze the data. Once the data has been analyzed, the ECU determines whether an adjustment of various engine components is necessary to improve performance.

Currently, various portable devices exist that allow users to connect to the ECU via a vehicle's on-board diagnostics (OBD) port. Typically, once the device is connect to the OBD port, certain of these devices may communicate with a computer, mobile phone, or other suitable electronic device to provide the user with diagnostics information beyond conventional data (such as mileage, tire pressure, oil level, etc.) that may be provided by a typical dashboard display. For example, certain devices may allow users to monitor driving habits or patterns, such as acceleration, deceleration, and braking tendencies. Other devices may allow users to track and monitor maintenance schedules, such as oil changes, tire rotations, registrations, and inspections. Typically, such prior art devices focus primarily on connecting with a vehicle to provide performance or other vehicle information to a user. However, the present inventors have recognized that none of these devices allow a user to easily and quickly connect to the ECU and tune the ECU to improve vehicle performance as desired.

The present inventors have, therefore, determined that it would be desirable to have a monitoring device with improved performance features that provide a user with diagnostic tools to monitor vehicle performance and to easily reprogram and/or tune the engine control unit to adjust and improve performance as desired without requiring specialized equipment and/or expertise from an automobile shop. Additional aspects and advantages of such a monitoring device will be apparent from the following detailed description of example embodiments, which proceed with reference to the accompanying drawings.

Understanding that the drawings depict only certain embodiments and are not, therefore, to be considered limiting in nature, these embodiments will be described and explained with additional specificity and detail with reference to the drawings.

### BRIEF DESCRIPTION OF THE DRAWINGS

FIG. 1 is a view of a dongle device for monitoring and tuning engine performance in accordance with one embodiment.

FIG. 2 is a view of the dongle device of FIG. 1 with a portion removed to illustrate internal features of the dongle device.

FIG. 3 is a schematic drawing illustrating internal electronics components of the dongle device of FIG. 1 and their interaction with external devices.

FIG. 4 is a flowchart illustrating an example method of installing and using the dongle device of FIG. 1.

FIG. 5 is a flowchart illustrating an example method of using the dongle device of FIG. 1 to communicate with the vehicle ECU.

FIG. 6 is a flowchart illustrating an example method of using the dongle device of FIG. 1 to run diagnostic protocols.

FIG. 7 is a flowchart illustrating an example method of using the dongle device of FIG. 1 to tune the ECU to improve performance.

### DETAILED DESCRIPTION OF DISCLOSED EMBODIMENTS

With reference to the drawings, this section describes particular embodiments and their detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

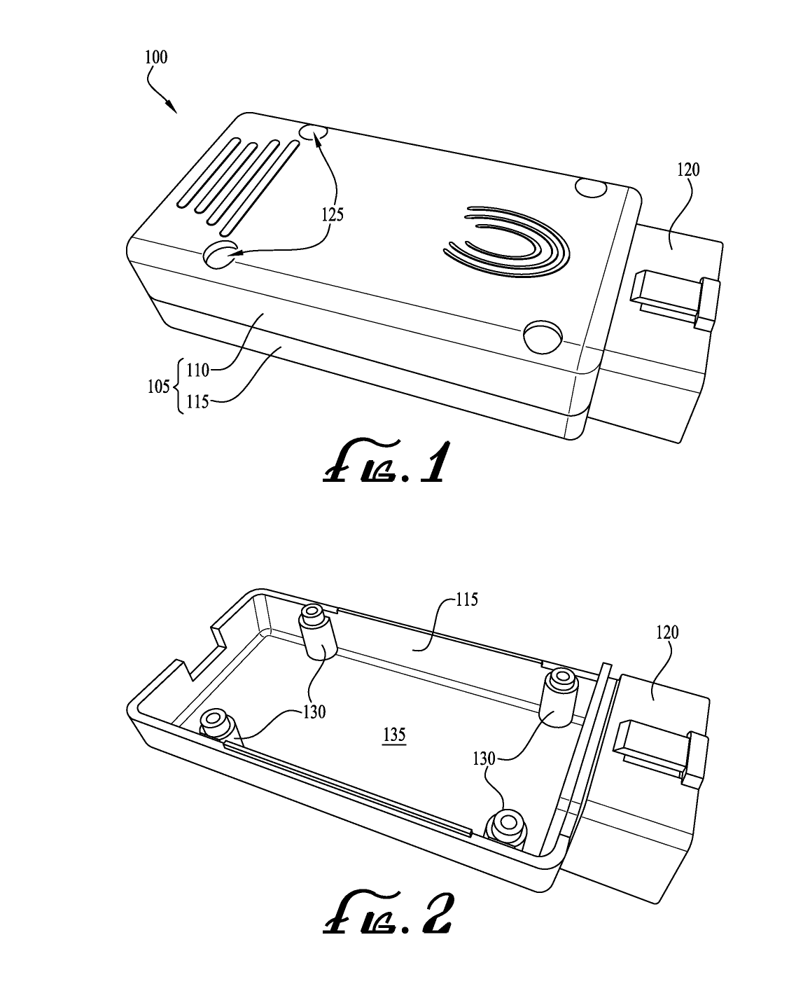

FIGS. 1-7 collectively illustrate embodiments of a portable dongle device 100 and methods for installing and using the dongle device 100 to communicate with a vehicular engine control unit (ECU) 145 and allow a user to utilize diagnostic tools to tune the ECU 145 and adjust/improve vehicular performance. Briefly, the dongle device 100 may include a housing 105 and a connector body 120 extending outwardly from the housing 105. The connector body 120 includes mating features for connecting the dongle device 100 with an on-board diagnostics (OBD) port 185 of a vehicle to communicate with the ECU 145. Once the dongle device 100 is connected, the dongle device 100 may send wireless signals or otherwise communicate with a mobile phone, tablet, computer, or other suitable electronic device to allow a user to access diagnostic information and adjust/tune the ECU 145 as desired to adjust/improve vehicular performance. With reference to FIGS. 1-7, the following sections describe additional details of this embodiment and others of the dongle device 100, along with details relating to methods of installation and use of the dongle device 100, and methods for receiving advertisements and other information that may be useful to the user based on the diagnostics information obtained via the dongle device 100.

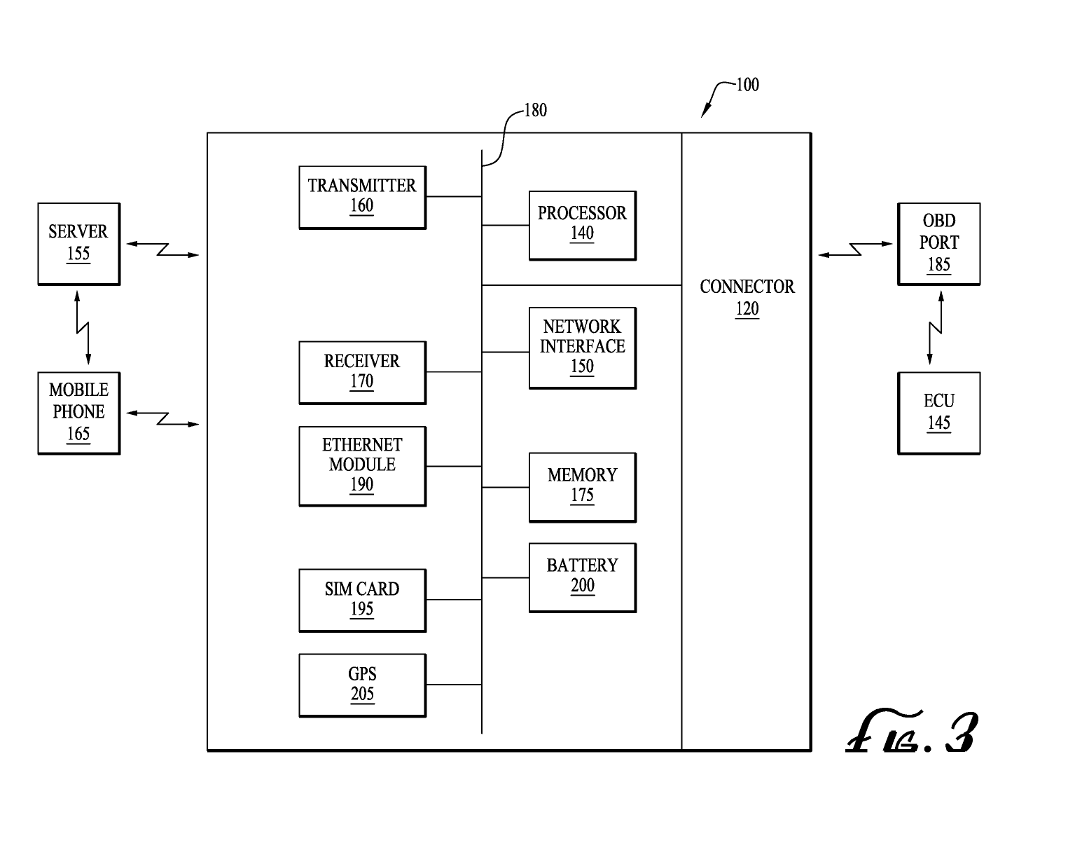

With particular reference to FIGS. 1 and 2, the dongle device 100 includes a housing 105 that may be in a clamshell configuration, the housing 105 including a first (or upper) housing portion 110 and a second (or lower) housing portion 115. The second housing portion 115 includes a connector body 120 extending outwardly therefrom for connecting the dongle device 100 to an OBD port 185. Preferably, one portion of the housing 105 (e.g., second housing portion 115 in FIG. 2) and the connector body 120 are manufactured of a plastic material as a single, monolithic component, with the other portion of the housing 105 (e.g., the first housing portion 110) being formed as a separate component that is coupled to the second housing portion 115 as described in further detail below. In other embodiments, the first and second housing portions 110, 115 and the connector body 120 may instead be manufactured from any other suitable materials and/or may be unitary components that are coupled or otherwise connected together.

In some embodiments, the first housing portion 110 may include a plurality of openings 125 extending therethrough, and the second housing portion 115 may include a plurality of corresponding bosses 130 extending upwardly from an interior surface 135 of the second housing portion 115. The bosses 130 are arranged to align with the openings 125 when the first and second housing portions 110, 115 are brought together. A plurality of screws or other fasteners (not shown) may be inserted through the openings 125 and secured within the bosses 130 to assemble the dongle device 100. It should be understood that in other embodiments, the openings 125 may instead be formed on the second housing portion 115 and the bosses 130 may instead be formed on the first housing portion 110.

In other embodiments, the first and second housing portions 110, 115 may instead be secured together using other suitable securing mechanisms, such as a plurality of snap-fit features instead of fasteners extending through openings and received in bosses. In such embodiments, the openings 125 and the bosses 130 may be omitted and replaced with corresponding snap-fit features. In still other embodiments, the first and second housing portions 110, 115 may be coupled together using other techniques, such as by using an adhesive.

As illustrated in FIGS. 1 and 2, the connector body 120 may be a 16-pin, D-shaped male connector operable to mate with a conventional OBD-II port 185, which is typically a 16-pin, D-shaped female connector included in many modern vehicles. Since the OBD-II port is most commonly used in modern vehicles, the written description specifically references use of the dongle device 100 with an OBD-II port. However, it should be understood that while reference is made to using the dongle device 100 with a vehicle's OBD-II port, the description is also meant to encompass use of the dongle device 100 with an OBD-I port, or differently-configured ports, including those that may be included in vehicles from foreign markets.

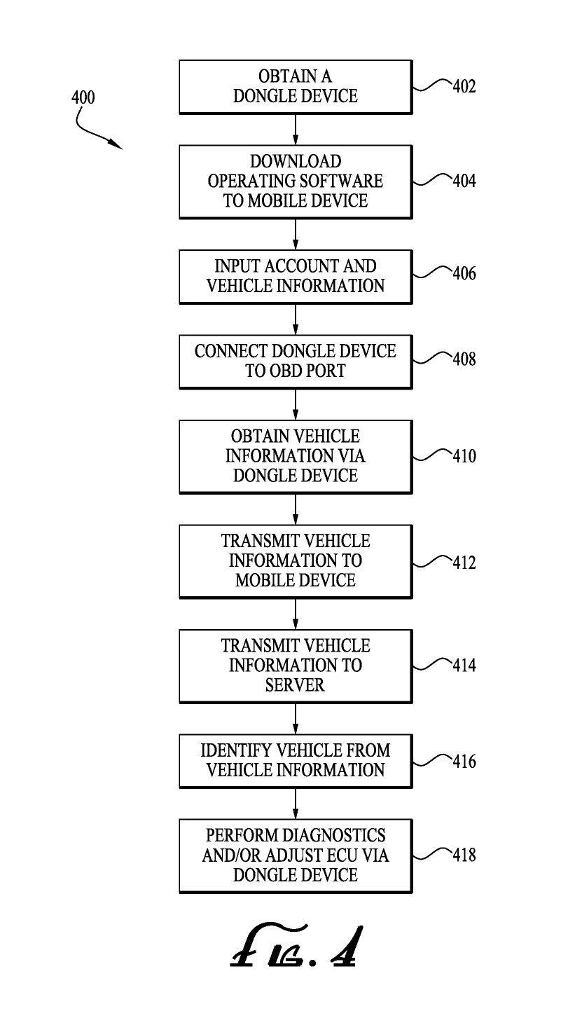

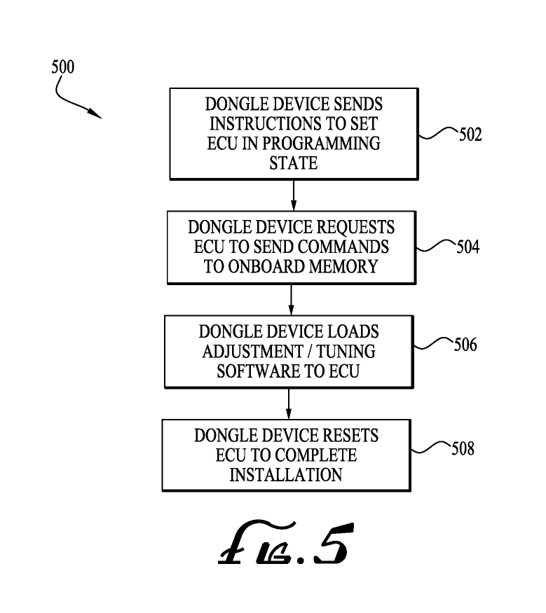

FIG. 3 illustrates a schematic diagram of the internal electronic components of the dongle device 100, and their communication with other exterior devices. With reference to FIG. 3, the dongle device 100 includes a processor 140, which may be any of various suitable commercially available processors or other logic machine capable of executing instructions. In some embodiments, suitable dual microprocessors or other multi-processor architectures may also be employed as the processor 140. When the dongle device 100 is connected to the ECU 145 via the connector body 120, the processor 140 communicates with the ECU 145 to receive and transmit diagnostics information and tuning instructions as is further described in detail below with reference to FIGS. 4-7.

The dongle device 100 includes a network interface 150 to facilitate communication with one or more other devices, such as a server 155, a mobile device or phone 160, a computer, or any other suitable device. For example, when the dongle device 100 is connected to the OBD-II port 185, the processor 140 may receive vehicle identification information (such as model, year, VIN number, etc.) from the ECU 145 and transmit the vehicle identification information to the server 155. Once the server 155 verifies the information, the server 155 communicates with the processor 140 via the network interface 150 to confirm the vehicle information. Additional details of these and other embodiments are further described below with reference to FIGS. 4-7.

The network interface 150 may facilitate wired or wireless communication with other devices over a short distance (e.g., Bluetooth™) or nearly unlimited distances (e.g., via the Internet). Preferably, the dongle device 100 uses a wireless connection, which may use low or high powered electromagnetic waves to transmit data using any wireless protocol, such as Bluetooth™, IEEE 802.11b (or other WiFi standards), infrared data association (IrDa), and radio frequency identification (RFID). In the case of a wired connection, a data bus may be provided using any suitable protocol, such as IEEE 802.3 (Ethernet), advanced technology attachment (ATA), personal computer memory card international association (PCMCIA), and USB. To facilitate a wired networking environment, the dongle device 100 may further include an Ethernet module 190 or other suitable modem module. In other embodiments, the dongle device 100 may include a SIM card 195 to allow the dongle device 100 to communicate directly with the server 155 for fully autonomous use (e.g., to avoid requirement of using a phone or mobile device).

The dongle device 100 further includes a transmitter 160 operable for transmitting data from the dongle device 100 to the server 155, to the mobile phone 165, or to another device. The dongle device 100 also includes a receiver 170 operable for receiving data from server 155, mobile phone 165, or any other device paired with the dongle device 100, and communicating the received data to the processor 140.

The dongle device 100 further includes a memory unit 175, which may be implemented using one or more suitable memory devices, such as RAM and ROM devices, secure digital (SD) cards, or other similar devices. In one embodiment, any number of program modules may be stored in the memory unit 175, including an operating system, one or more application programs, ECU tuning protocols, past tuning storage files, customer data, vehicle and performance data, device settings, and/or any other suitable modules for operation of the dongle device 100. In other embodiments, the dongle device 100 may monitor driving habits and may store the information in the memory unit 175 or may transmit the information to the server 155 for future use. For example, if a driver is involved in an accident, the dongle device 100 may be consulted to determine if the driver was driving over the posted speed limit or to determine if the driver used the brakes prior to air bag deployment.

In some embodiments, the dongle device 100 may further include a battery supply 200 for powering the electronics and other features of the device 100. In other embodiments, the dongle device 100 may instead draw power from the OBD-II port 185 when the device 100 is connected.

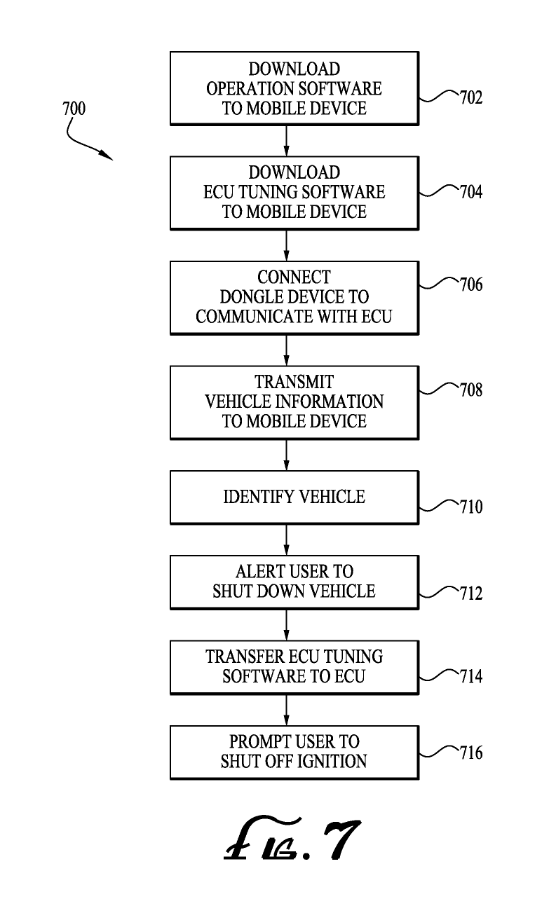

In addition, in other embodiments, the dongle device 100 may further include a global positioning system (GPS) 205 operable for determining a geographic location of the dongle device 100. As further explained in detail below with reference to FIG. 6, the GPS 205 may be used to determine a location of the device 100 and to send targeted advertisements to the user for repair shops and/or service providers that may be in the vicinity so that the user can address any performance issues of the vehicle. In some embodiments, the GPS 205 of the dongle device 100 may be in communication with the mobile device 165, where the mobile device 165 obtains the GPS location of the dongle device 100 from the GPS 205 and communicates with the database/server 155 to receive the advertisements based on the GPS location.

The above-described components of the dongle device 100, including the processor 140, the network interface 150, the transmitter 155, the transmitter 160, the receiver 170, the memory 175, the battery 200, and the GPS 205 may be interconnected via a bus 180. It should be understood that while a bus-based architecture is illustrated in FIG. 3, other types of architectures are also suitable. In addition, in some embodiments, one or more components may be directly coupled to one another or combined as a single unit. For example, the transmitter 160 and receiver 170 may be combined into a single transceiver unit (not shown) to save space, provide an efficient component arrangement within the dongle device 100, and reduce circuitry requirements.

In addition, while the illustrated embodiment depicts one possible configuration for the dongle device 100, it should be recognized that a wide variety of hardware and software configurations may be provided without departing from the principles of the described embodiments. For example, other versions of the dongle device 100 may have fewer than all of these components or may contain additional components.

FIGS. 4-7 collectively illustrate example methods for installing and using the dongle device 100 to obtain diagnostic information from a vehicle and tune the ECU 145 to improve performance as desired. It should be understood that while the description of the method steps may present and describe certain steps in a particular order, the order is for convenience and is not meant to be limiting. In some embodiments, the steps may be performed in an order different than what is specified herein. In addition, the method may include additional steps and features other than those included herein. In some embodiments, the method may combine certain steps or omit certain steps altogether.

With reference to FIG. 4, the method 400 illustrates an example embodiment relating to configuring the dongle device and preparing it for use with an OBD-II port. At step 402, a user obtains a dongle device, such as by renting or purchasing the device from a vendor. Thereafter, at step 404 the user downloads software (such as an application or program) to a mobile phone, computer, tablet, or other suitable electronic device, where the application/program may be used to interact with the dongle device (such as to receive data or send commands, etc.). Once the application is downloaded to the selected electronic device, at step 406, the user accesses the application or program, creates an account, and inputs vehicle information, such as vehicle year, make, model, vehicle identification number (VIN). The application may also allow the user to configure the dongle device as desired.

At step 408, the user connects the dongle device to the OBD-II port of the vehicle. In one embodiment, connecting the dongle device into the vehicle OBD-II port supplies power to the device so that the device can interact with a mobile phone or other selected suitable electronic device. At step 410, the dongle device obtains vehicle information (such as vehicle model, year, and VIN) via the OBD-II port. Thereafter, at step 412, the dongle device transmits the vehicle information to the mobile phone, which in turn transmits the information to the server at step 414 to identify the vehicle. In some embodiments, steps 414 may be omitted and the dongle device may instead transmit the vehicle information directly the server. At step 416, the server may compare the vehicle information obtained via the dongle device with the vehicle information provided by the user to identify the vehicle. In some embodiments, the application may also prompt the user to re-enter the VIN or other vehicle identification information to verify that the information entered by the user matches the vehicle identity determined by the server. If the vehicle identity as entered by the user does not match the vehicle identity determined by the server, then the application may request that the user re-enter the vehicle information or may provide additional options to the user for correcting the discrepancy. At step 418, if the identity information matches, then the user may perform diagnostics and/or adjust/tune the ECU via the dongle device, such as by using the application on the mobile device to select one or more options from a menu of available options. As mentioned below in step 602, the dongle device may be used to upload commands, software, or the like to adjust or activate any of a variety of vehicle functions controlled by the ECU. The precise instructions and commands that are uploaded from the dongle device to the ECU may vary depending on various factors, such as the make and model of the automobile and the existing ECU programming, for example.

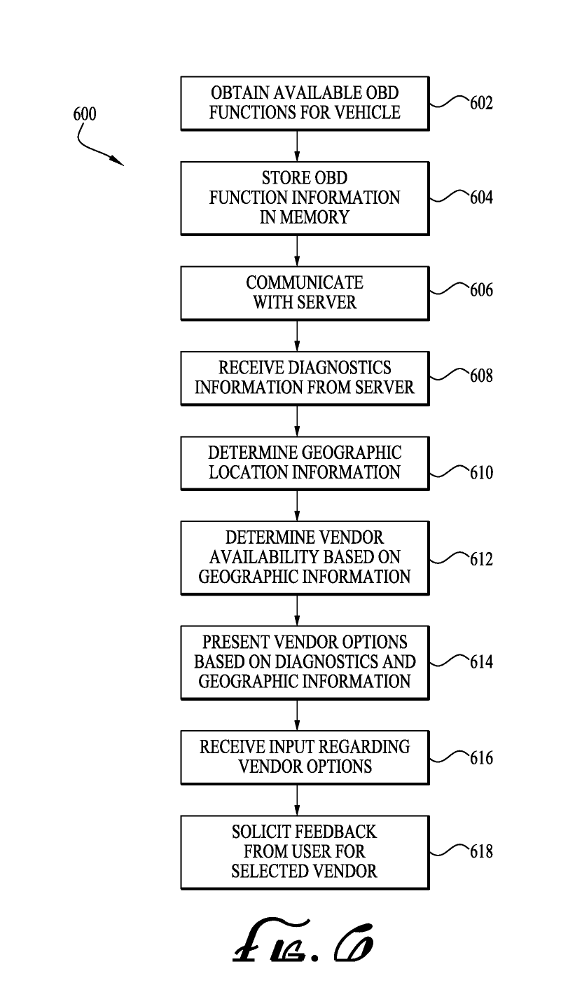

With reference to the example method 500 illustrated in FIG. 5 and discussed below, the following provides details regarding high-level communications between the dongle device and the ECU for adjusting the ECU as desired. At step 502, once the dongle device is connected to the ECU via the OBD port, the dongle device sends instructions to set the ECU in a programming state, which establishes a link for the ECU to receive a software or calibration update from the dongle device (or via a mobile device in communication with the dongle device). In some embodiments, the link may be used to upload the ECU software to the dongle, mobile device, or server for the tuning process. At step 504, after the user or other personnel determines which vehicle features/characteristics are going to be modified, the dongle device requests the ECU processor to send commands to the onboard memory circuit containing the software that is to be reprogrammed, where the commands may include instructions to erase the old software (that is, the software associated with the target features/characteristics that will be adjusted) at the portion of the memory where the new software/instructions (that is, the software for adjusting the target features/characteristics) will be loaded. Once the target location on the memory has been identified, at step 506, the new software is loaded to the ECU. It should be understood that in other embodiments, the new software may simply overwrite the old software without first having the old software wiped from the memory. At step 508, once the adjustment software is loaded to the ECU, the dongle device may transmit a command to reset the ECU to complete installation of the adjustment software, thereby completing the adjustment/tuning process.

FIGS. 6 and 7, described in further detail below, illustrate example methods 600, 700, respectively, for using the dongle device and application to perform diagnostics and adjust/tune the ECU.

FIG. 6 illustrates an example method 600 for performing diagnostics protocols via the dongle device and the application, which may be accessed through a mobile device or other electronic device. At step 602, the dongle device is connected to the OBD-II port and communicates with the ECU to obtain information relating to the OBD diagnostics functions that are available for the specific vehicle. In some embodiments, the dongle device commands/requests the ECU to run/activate all operations supported by the vehicle's ECU. For example, in some vehicles, the OBD functions may include monitoring mileage, error codes and warnings, fuel levels, temperature/pressure/boost levels, climate controls, safety controls, brakes, multimedia controls, maintenance issues, or other vehicle information. In still other embodiments, as mentioned previously, the dongle device may also obtain information about the driver's driving history, from which driving habits may be inferred. At step 604, the dongle device stores the monitoring results of step 602 in memory for future reference. Preferably, the dongle device remains connected to the OBD port indefinitely or for extended periods of time to continuously obtain diagnostics data and monitor vehicle performance and operation.

At step 606, the dongle device communicates with the server to retrieve information from the server relating to the vehicle. For example, the dongle device may transmit to the server information relating to vehicle-specific error codes, warnings, and/or service requirements to determine whether any steps need to be taken to address any potential vehicle issues. In some embodiments, the dongle device may communicate directly with the server via the transmitter. In other embodiments, the dongle device may use the transmitter to communicate with the application on the user's mobile device, which in turn communicates with the server.

At step 608, the server relays diagnostic information to the application on the mobile device (and, in some embodiments, to the dongle device via the receiver). For example, depending on the nature of the specific error codes, warnings, and/or service information obtained by the dongle device, the server may determine that an oil change is required, or that vehicle oil temperature/pressure is too high and requires inspection, or an engine part is malfunctioning and requires replacement.

At step 610, once a determination has been made that the vehicle requires parts and/or servicing and the server has communicated that information to the user via the application, the application may automatically determine the user's geographic location, such as by accessing the Global Positioning System (GPS) on the user's mobile device (e.g., cell phone, tablet, or computer) or communication with an onboard GPS of the vehicle. In other embodiments, the application may ask the user to input the user's location information, such as by specifying city and state information, zip code information, landmark information, or other geographic information that may be used to identify the user's location. In still other embodiments, the dongle device may include a GPS or other geographic location system that communicates the geographic location of the dongle device directly to the server via the transmitter, or indirectly to the server through the application on the mobile device.

At step 612, once the server receives the geographic information relating to the user's location (or user's vehicle location), the server queries a database to determine whether there are any vendors in the user's vicinity that may be able to service the vehicle or replace damaged parts identified in step 608. In some embodiments, the user may specify proximity distance intervals from the user (e.g., within 5 miles, 10 miles, 15 miles, etc.), preferred shops, or other suitable criteria.

Based on the user's specified criteria and the services/parts offered by the identified vendors in the user's area, at step 614, the application presents the vendor options to the user. The options may be prioritized based on ratings/reviews from other users, price for service/parts, and/or the user's own specified criteria. At step 616, the user may use the application to create an appointment with the selected vendor for servicing the vehicle. In some embodiments, instead of or in addition to creating an appointment with the vendor, the application may present the user with a menu to purchase required vehicle parts, such as through a selected vendor's website to have that part shipped to the vendor, the user's home, or any other suitable location. After the vehicle is serviced, at step 618, the application may solicit feedback from the user, such as by seeking a written review, a rating selection, or other information. The user's feedback may be stored on the server and used when determining future recommendations to the user.

In some embodiments, the application may display promotions and advertisements to users based on the user's geographic location and service requirements. For example, if the user requires an oil change as determined by the dongle device and server, the application may query the server for advertisements relating to oil changes and vendors in the user's geographic location. If any advertisements are found, the application may display the advertisement to the user.

FIG. 7 illustrates an example method 700 for performing advanced diagnostics and running protocols to adjust/tune a vehicle ECU via the dongle device. Prior to using the dongle device for adjusting the operational parameters of the ECU, the dongle device and/or the user's mobile device (or other electronic device) may require specialized software and may seek user registration information similar to step 404 of method 400 to properly configure both the dongle device and the application on the mobile device. Accordingly, at step 702, the user downloads software (such as an application) to a mobile phone, computer, tablet, or other suitable electronic device that will be used in conjunction with the dongle device.

At step 704, the user downloads specialized ECU tuning software from the server via the mobile device and transfers the software to the dongle device. The mobile device may communicate with the receiver of the dongle device to transfer the software package, which is thereafter stored in the memory and executable via the processor. In some embodiments, the application may request permission from the user prior to initiating the software package transfer to the dongle device.

It should be understood that in some embodiments, the ECU adjusting/tuning software may include different features based on vehicle year and model and the capabilities of the ECU for the specific vehicle being serviced. For example, in one vehicle, the ECU may control ignition timing and the adjusting/tuning software may be used to adjust the exact timing of the ignition timing or spark to provide better power and/or fuel economy. In another vehicle, the software may adjust valve timing to control the time in the engine cycle at which engine valves open to optimize the flow of air into the cylinder, thereby increasing power and/or fuel economy. In still other vehicles, the ECU may control other performance features such as air-to-fuel ratio and RPM limits on the engine. It should be understood that each of these control features and any other features that may be controlled by the ECU for a specific vehicle may also be adjustable via the ECU tuning software to improve vehicle performance using the dongle device.

At step 706, the dongle device is connected to the OBD-II port and communicates with the ECU. While connected, the dongle device may obtain vehicle identification information (including vehicle model, year, VIN) and, at step 708, the dongle device transmits the vehicle information to the mobile phone, which in turn transmits the information to the server at step 710 to identify the vehicle. Once the vehicle is identified, at step 712, the application alerts the user that the car will shut down (e.g., the lights and gauges will turn off). In some embodiments, the application may seek a response from the user to verify that the car has shut down, such as by requiring the user to actuate a button or menu option before proceeding.

Thereafter, at step 714, the dongle device transfers to or otherwise uploads onto the ECU the specialized tuning software to adjust desired operational parameters of the ECU. The user may select a particular package from among various software packages depending on the features that the user would like to adjust/tune and the features available for adjustment with the specific vehicle. In other embodiments, the user may instead select to return the ECU to its stock mapping. Once the software transfer is complete, the dongle device awakens the vehicle (e.g., turns on the lights and the gauges). At step 716, the application/program may direct the user to shut off the ignition switch and disconnect the dongle device from OBD-II port. After restarting the vehicle, installation of the ECU performance tune software is complete and the ECU is tuned in accordance with the protocols that were originally installed. When desired, steps 704 through 718 may be repeated as needed to alter ECU performance and/or return the vehicle to stock mapping as desired.

It should be understood that while the methods for using and installing the monitoring device have been described in a particular order, the described order is merely for illustration purposes only and is not intended to enumerate a specific order of steps. In other embodiments, the steps in the described methods may be accomplished in a different order without affecting the outcome of the process.

It is intended that subject matter disclosed in any one portion herein can be combined with the subject matter of one or more other portions herein as long as such combinations are not mutually exclusive or inoperable. In addition, many variations, enhancements and modifications of the concepts described herein are possible.

The terms and descriptions used above are set forth by way of illustration only and are not meant as limitations. Those skilled in the art will recognize that many variations can be made to the details of the above-described embodiments without departing from the underlying principles of the invention.

1. A device for adjusting automotive operation parameters of a vehicle, the device comprising:
a connector having one or more engagement features operable to connect to an on-board diagnostics port of the vehicle;
a processor operable to communicate with an engine control unit of the vehicle when the connector is connected to the on-board diagnostics port, the processor configured to obtain vehicle information from the engine control unit;
a transmitter in operative communication with the processor and in wireless communication with a remote server, the transmitter configured to transmit to the remote server the vehicle information obtained by the processor from the engine control unit; and
a receiver in wireless communication with the remote server and the processor, the receiver configured to receive instructions for adjusting operational parameters of the engine control unit, wherein the receiver communicates the instructions to the processor, and wherein the processor adjusts the operational parameters of the engine control unit based on the instructions.

2. The device of claim 1, wherein the vehicle information comprises vehicle identification information, and wherein the transmitter is further configured to communicate the vehicle identification information to the remote server to identify the vehicle.

3. The device of claim 1, wherein the vehicle information comprises diagnostics information relating to a performance characteristic of the vehicle, and wherein the transmitter is further configured to communicate the diagnostics information to the remote server to identify whether a vehicle performance issue exists.

4. The device of claim 3, wherein when a vehicle performance issue is identified, the receiver is further configured to receive an instruction protocol from the remote server, the protocol containing instructions for resolving the vehicle performance issue, and wherein the processor is further configured to transmit the instruction protocol to the engine control unit.

5. The device of claim 3, further comprising a memory module in communication with the processor, the memory module storing the diagnostics information therein.

6. The device of claim 1, further comprising a memory module in communication with the processor, the memory unit storing the vehicle identification information therein.

7. A system for adjusting automotive operation parameters of a vehicle, the system comprising:
a database; and
a dongle device, the dongle device comprising:
a connector configured to connect with an on-board diagnostics port of the vehicle;
a processor in communication with an engine control unit of the vehicle when the connector is connected with the on-board diagnostics port, the processor configured to obtain vehicle information relating to the vehicle from the engine control unit;
a transmitter in communication with the processor and in wireless communication with the database, the transmitter configured to transmit to the database the vehicle information obtained by the processor from the engine control unit; and
a receiver in wireless communication with the database and the processor, the receiver configured to receive instructions for adjusting operational parameters of the engine control unit, wherein the receiver communicates the instructions to the processor, and wherein the processor adjusts the operational parameters of the engine control unit based on the instructions.

8. The system of claim 7, further comprising a mobile device in wireless communication with the database, the mobile device configured to receive a selection relating to a set of instructions for adjusting the operational parameters of the engine control unit and to transmit the selection to the database, wherein in response to receiving the selection, the database communicates the set of programming instructions to the dongle device, and wherein the dongle device is further configured to communicate the set of programming instructions to the engine control unit.

9. The system of claim 7, further comprising a mobile device in wireless communication with the dongle device, the mobile device configured to receive a selection relating to a set of instructions for adjusting the operational parameters of the engine control unit and to transmit the selection to the dongle device, wherein in response to receiving the selection, the dongle device communicates the selection to the database, wherein in response to receiving the selection, the database communicates the set of instructions to the dongle device, and wherein the dongle device is further configured to communicate the set of instructions to the engine control unit.

10. The system of claim 7, wherein the vehicle information comprises diagnostics information relating to a performance characteristic of the vehicle, and wherein the transmitter is further configured to communicate the diagnostics information to the database to identify whether a vehicle performance issue exists.

11. The system of claim 10, further comprising a mobile device in wireless communication with the dongle device, wherein the dongle device is further configured to communicate the diagnostics information and the identified vehicle performance issue to the mobile device.

12. The system of claim 10, further comprising a mobile device in wireless communication with the database, wherein the database is further configured to communicate the diagnostics information and the identified vehicle performance issue to the mobile device.

13. The system of claim 7, the dongle device further including a GPS location system operable to determine a geographic location of the dongle device.

14. The system of claim 13, further comprising a mobile device in communication with the dongle device and the database, wherein the database is operable to transmit advertisements to the mobile device based on the determined geographic location of the dongle device.

15. A method for adjusting operational parameters of a vehicle via a dongle device connected to an on-board diagnostics port of the vehicle, the method comprising:
obtaining, via the dongle device, vehicle information from an engine control unit of the vehicle;
communicating, via the dongle device, the vehicle information from the dongle device to a database to identify the vehicle;
receiving, via a receiver of the dongle device, diagnostics information from the engine control unit;
transmitting, via a transmitter of the dongle device, the diagnostics information to the database;
receiving, via the receiver of the dongle device, adjustment instructions based on the diagnostics information; and
adjusting, via the dongle device, the engine control unit of the vehicle based on the adjustment instructions.

16. The method of claim 15, further comprising:
receiving, via the receiver of the dongle device, a request to wirelessly pair the dongle device with a mobile device; and
transmitting, via a transmitter of the dongle device, a message to the mobile phone confirming that the dongle device and the mobile device are wirelessly paired.

17. The method of claim 16, further comprising receiving, via the receiver of the dongle device, adjustment instructions from the mobile device based on the diagnostics information.

18. The method of claim 16, further comprising:
determining, via the dongle device, a geographic location of the dongle device;
communicating, via the dongle device, the geographic location to the database; and
transmitting, via the database, advertisements to the mobile device based on the geographic location of the dongle device.

19. The method of claim 16, further comprising:
determining, via the mobile device, a geographic location of the dongle device;
communicating, via the mobile device, the geographic location to the database; and
transmitting, via the database, advertisements to the mobile device based on the geographic location of the dongle device.
